(19) United States
(12) Patent Application Publication
(10) Pub. No.: US 2015/0217421 A1
(43) Pub. Date: Aug. 6, 2015

(54) SAFETY SYSTEMS FOR POWER EQUIPMENT

(71) Applicant: Stephen F. Gass, West Linn, OR (US)

(72) Inventor: Stephen F. Gass, West Linn, OR (US)

(73) Assignee: SD3, LLC, Tualatin, OR (US)

(21) Appl. No.: 14/170,539

(22) Filed: Jan. 31, 2014

(51) Int. Cl. B23Q 17/24; B27G 19/02; B23Q 11/00; B26D 7/24

(52) U.S. Cl. CPC B23Q 17/2438; B26D 7/24; B27G 19/02; B23Q 11/0082

(57) ABSTRACT

Woodworking machines including a blade to cut a workpiece and a detector to detect movement or position of at least part of a human body near the blade and a reaction system adapted to mitigate possible injury upon detection of a dangerous condition between the human and the blade.

### CROSS-REFERENCE TO RELATED APPLICATION

This application claims the benefit of and priority from U.S. Provisional Patent Application Ser. No. 61/762,594, filed Feb. 8, 2013, which is incorporated herein by reference.

### TECHNICAL FIELD

The present invention relates to safety systems for power equipment. More specifically, this specification relates to safety systems which include motion sensors and software analysis tools, such as the Leap Motion controller, to detect hazardous conditions occurring during the use of power tools such as table saws, sliding table saws, joiners, up-cut saws and other machinery typically found in woodworking shops.

### BACKGROUND

Safety systems may be employed with power equipment to minimize the risk of injury when using the equipment. Some safety systems include an electronic system to is detect the occurrence of a dangerous condition and a reaction system to minimize any possible injury from the dangerous condition. For instance, some safety systems attempt to detect when a human body contacts or comes into dangerous proximity to a predetermined portion of a machine, such as detecting when a user's hand touches the moving blade of a saw. As another example, the safety system may be configured to detect the rapid movement of a workpiece due to kickback by a cutting tool. When a dangerous condition is detected, the safety system reacts to minimize injury. Motion detectors can be used in safety systems but generally they are limited in their ability to distinguish what objects are in motion and to track their motion accurately.

A controller made by a company called Leap Motion purportedly provides an area of 3D interaction space of roughly eight cubic feet in which human body parts and gestures as well as other objects and their movement may be identified and monitored with an alleged accuracy of tracking individual finger movements to 1/100th of a millimeter. With this technology it may be possible to identify the type of object that is moving, ie. whether a human hand or a specific tool, and to track the movement anywhere in the 3D interaction space with a speed and accuracy that allows for the identification of a hazardous condition and a fast response of the safety system to prevent or greatly minimize injury. While the Leap Motion controller uses optical sensors, there are other technologies that may be used as well, such as a motion sensor from the company Elliptic Labs that detects hand motion and gestures using ultrasonic sensors.

The present invention relates to the incorporation into power equipment of safety systems that include motion detectors, such as a Leap Motion controller or an Elliptic is Labs controller, adapted to detect a dangerous situation such as when a portion of a person's body comes in close proximity to the blade or other cutting tool to protect the user against serious injury if a dangerous, or triggering, condition, such as contact between the user's body and the blade or other cutting tool, occurs. Data from the motion detector is used to trigger a reaction mechanism that quickly takes some action to minimize injury.

### BRIEF DESCRIPTION OF DRAWINGS

FIG. 1 shows a table saw.

FIG. 2 is a schematic block diagram of a machine with a fast-acting safety system.

FIG. 3 is a schematic diagram of an exemplary safety system in the context of a machine having a circular blade.

### DETAILED DESCRIPTION

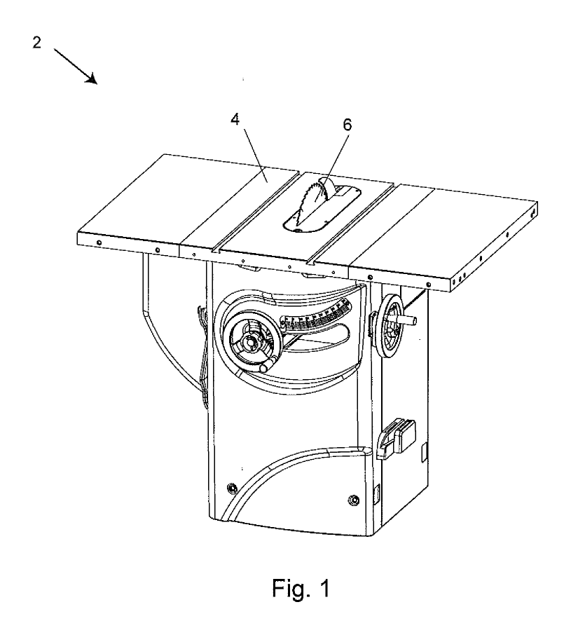

A table saw 2 is shown in FIG. 1. Saw 2 includes a table 4 and a circular blade 6 that extends up through the table. A piece of wood, or other material to be cut, is placed on the table and pushed into contact with the spinning blade to make a cut. The saw in FIG. 1 is one example of a cutting machine typically used in a wood-working shop. Other cutting machines may include joiners, sliding table saws, up-cut saws, band saws etc. In all these cases, cuts are made to a workpiece by a rapidly moving cutting tool, such as a blade or cutter head, that may be of a considerable size or weight. The cutting tool poses a serious risk of injury to the user of the machinery if the user were to accidently contact the cutting tool while in operation.

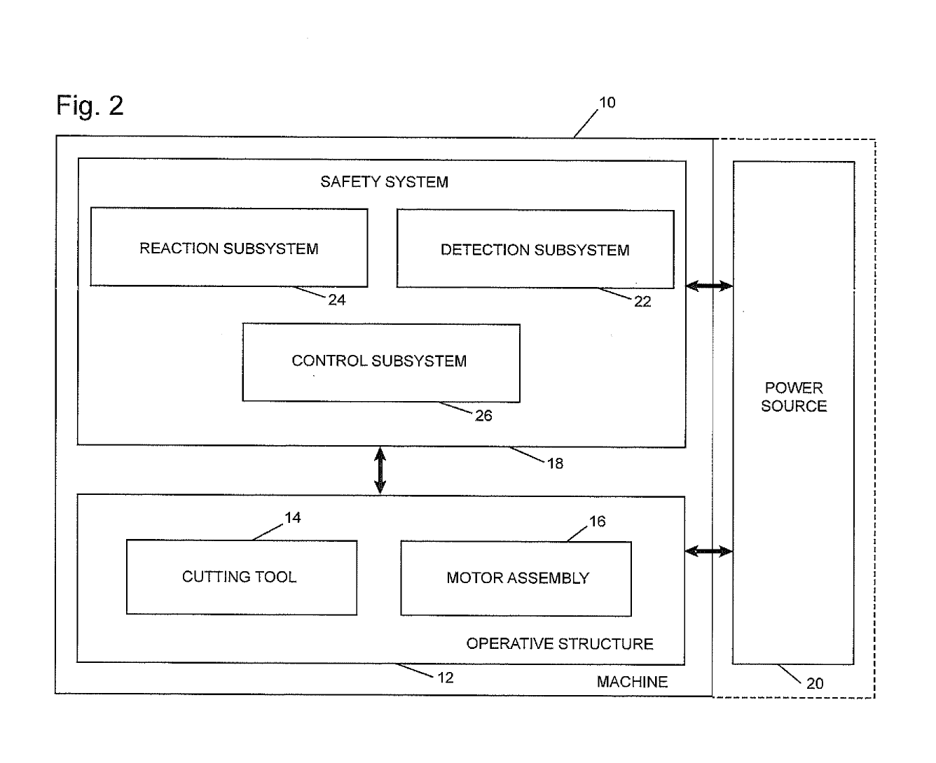

FIG. 2 shows a block diagram of a cutting machine 10 that incorporates a safety system. Machine 10 may be any of a variety of different machines, such as table saws, miter saws, band saws, jointers, shapers, routers, hand-held circular saws, up-cut saws, sanders, etc. Machine 10 includes an operative structure 12 having a working or cutting tool 14 and a motor assembly 16 adapted to drive the cutting tool. The particular form of cutting tool 14 will vary depending upon the various embodiments of machine 10. For example, cutting tool 14 may be a single, circular rotating blade having a plurality of teeth disposed along the perimetrical edge of the blade, such as in the saw of FIG. 1. Alternatively, the cutting tool may be a plurality of circular blades, such as a dado blade or dado stack, or some other type of blade, cutter head or working tool.

Machine 10 includes a safety system 18 configured to minimize the potential of a serious injury to a person using the machine. Safety system 18 is adapted to detect the occurrence of one or more dangerous conditions during use of the machine. If such a dangerous condition is detected, safety system 18 is adapted to engage operative structure 12 to limit any injury to the user caused by the dangerous condition. Exemplary safety systems are disclosed in International Publication Number WO 01/26064 A2, published Apr. 12, 2001, the disclosure of which is hereby incorporated by reference.

Machine 10 also includes a suitable power source 20 to provide power to operative structure 12 and safety system 18. Power source 20 may be an external power source such as line current, or an internal power source such as a battery. Alternatively, power source 20 may include a combination of both external and internal power sources. Furthermore, power source 20 may include two or more separate power sources, each adapted to power different portions of machine 10.

Safety system 18 includes a detection subsystem 22, a reaction or danger mitigation subsystem 24 and a control subsystem 26. Control subsystem 26 may be adapted to receive inputs from a variety of sources including detection subsystem 22 and is configured to control machine 10 in response to the inputs it receives. Detection subsystem 22 is configured to detect one or more dangerous or triggering conditions during use of machine 10 such as when a portion of the user's body is dangerously close to or in contact with a portion of cutting tool 14 or when there is rapid movement of a workpiece due to kickback by the cutting tool. In some embodiments, detection subsystem 22 may inform control subsystem 26 of the dangerous condition, which then activates reaction subsystem 24. In other embodiments, the detection subsystem may be adapted to activate the reaction subsystem directly. Once activated in response to a dangerous condition, reaction subsystem 24 is configured to engage or act on operative structure 12 quickly to prevent serious injury to the user. Examples of detection subsystems, reaction subsystems and control subsystems are disclosed in International Publication Number WO 01/26064 A2, published Apr. 12, 2001, which is incorporated by reference.

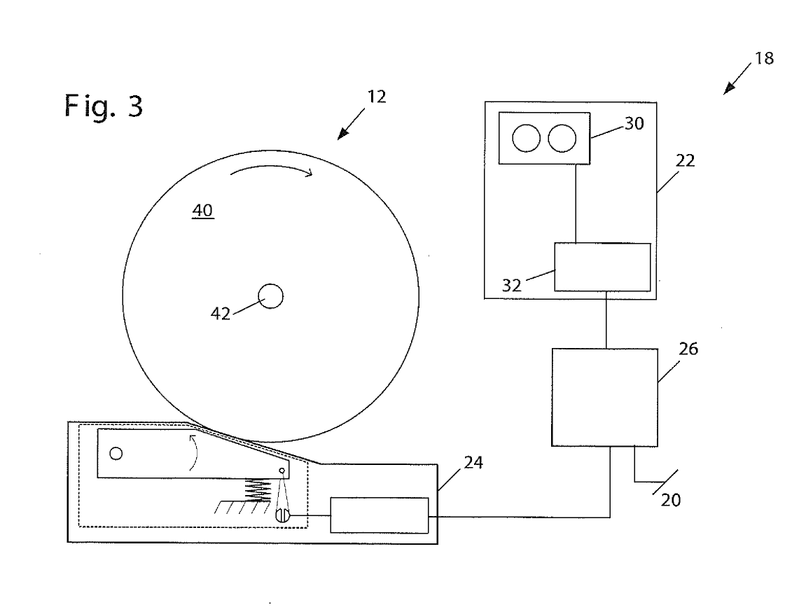

The system shown in FIG. 2 and described above may be implemented in a variety of ways depending on the type and configuration of operative structure 12. FIG. 3 shows one example of the many possible implementations of safety system 18. System 18 is configured to engage an operative structure having a circular blade 40 mounted on a rotating shaft or arbor 42. For example, a brake pawl can engage and stop the blade from spinning upon detection of a dangerous condition. Additionally or alternatively, the arbor can be supported by an arbor support that is free to pivot under a strong enough torque so that the blade can retract downward upon detection of a dangerous condition. For example, the reaction subsystem 24 can be adapted to engage the blade to stop the blade which, by the conservation of angular momentum, draws the arbor support that supports the arbor down to retract the blade.

Detection subsystem 22 is implemented by a motion detector, or hand tracking system, such as a Leap Motion controller, which is a USB peripheral device consisting of a sensor 30 that may be mounted above, below or to the side of the blade and workspace area to monitor the user work area around the blade, and a processing unit 32 to run software, such as Leap Motion enabled software. One Leap Motion controller can purportedly monitor up to roughly eight cubic feet of three-dimensional space, and several Leap Motion controllers can be hooked up together to cover an even larger space. The Leap Motion sensor senses objects optically within the three-dimensional interaction space using infrared LEDs and cameras. Accordingly, in this embodiment, sensor 30 may be one or more infrared cameras, and sensor 30 may also include one or more infrared LEDs. The processing functionality of the Leap Motion controller is determined by the software that is loaded into the controller. The Leap Motion enabled software together with the high-performance Leap Motion sensor purportedly provide a powerful detection system capable of recognizing and distinguishing the human hand from other objects typically used while operating the saw. This allows the detector to identify various safety hazards including but not limited to situations where a human body contacts or comes dangerous close to the moving blade of a saw or when a workpiece moves suddenly and rapidly back toward the operator of the saw due to kickback. This information may then be used to trigger or signal the reaction mechanism which than acts to minimize or prevent injury.

Other motion sensors could also be used, such as the Elliptic Labs motion sensor which uses ultrasonic sensors. In this embodiment, sensor 30 shown in FIG. 30 would be one or more ultrasonic sensors and/or one or more ultrasonic emitters. The Elliptic Labs motion sensor technology is described in the following patent application publications, the disclosures of which are all herein incorporated by reference: US 2012/0313900 published Dec. 13, 2012, US 2012/0299820 published Nov. 29, 2012, US 2012/0274610 published Nov. 1, 2012, US 1012/0243374 published Sep. 27, 2012, US 2012/0206339 published Aug. 16, 2012, US 2012/0099403 published Apr. 26, 2012, US 201110254762 published Oct. 20, 2011, US 2011/0148798 published Jun. 23, 2011, US 2011/0103448 published May 5, 2011, US 2011/0096954 published Apr. 28, 2011, and US 2010/0296368 published Nov. 25, 2010.

Variations of the above-described embodiments are possible within the scope of this disclosure.

### INDUSTRIAL APPLICABILITY

The safety systems disclosed herein are applicable to woodworking power tool to equipment, and particularly to table saws.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub-combinations of the various elements, features, functions and/or properties disclosed herein. No single feature, function, element or property of the disclosed embodiments is essential to all of the disclosed inventions. Similarly, the recitation of “a” or “a first” element, or the equivalent thereof, should be understood to include incorporation of one or more such elements, neither requiring nor excluding two or more such elements.

It is believed that the following claims particularly point out certain combinations and sub-combinations that are directed to disclosed inventions. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A woodworking machine comprising:
a blade to cut a workpiece;
a motor to move the blade;
a detection system including a motion detector configured to detect a movement of at least a part of a human body near the blade; and
a reaction system adapted to perform a specified action to mitigate possible injury upon detection of the movement.

2. The woodworking machine of claim 1, where the motion detector includes a camera.

3. The woodworking machine of claim 1, where the motion detector includes an infrared camera.

4. The woodworking machine of claim 1, where the motion detector includes an infrared camera and an infrared LED.

5. The woodworking machine of claim 1, where the motion detector includes an ultrasonic sensor.

6. A woodworking machine comprising:
a blade to cut a workpiece;
a motor to move the blade;
motion detection means for detecting a movement of at least a part of a human body near the blade; and
a reaction system adapted to perform a specified action to mitigate possible injury upon detection of the movement.
